(19) United States
(12) Patent Application Publication
(10) Pub. No.: US 2015/0076397 A1
(43) Pub. Date: Mar. 19, 2015

(54) TURBIDITY REMOVAL SOLUTION

(71) Applicants: Hifza RASHEED, Islamabad (PK); Muhammad Aslam Tahir, Islamabad (PK)

(72) Inventors: Hifza RASHEED, Islamabad (PK); Muhammad Aslam Tahir, Islamabad (PK)

(21) Appl. No.: 14/030,872

(22) Filed: Sep. 18, 2013

(51) Int. Cl. C02F 1/52; C02F 1/68; C02F 1/50

(52) U.S. Cl. CPC C02F 1/5236; C02F 1/50; C02F 1/68; C02F 2303/04
USPC 252/175

(57) ABSTRACT

A composition for purifying raw water comprising alum, sodium carbonate, calcium hypochlorite and bentonice is described.

### BACKGROUND OF THE INVENTION

Over 1.1 billion people around the world do not have access to safe drinking water and over 2.4 billion people do not have access to adequate sanitation. This limitation puts these people, the world's poorest, at risk for contact with waterborne diseases such as cholera, dysentery, and typhoid fever. Many waterborne infections induce diarrhea, which causes 4% of the world's deaths and is the leading cause of deaths among children under the age of five. Several estimates indicate that about 200,000 child deaths occur each year in Pakistan due to water-borne diseases. Considering the severe water pollution, around 40% of all reported diseases and deaths in Pakistan are attributed to poor water quality. Unsafe drinking water is considered to lead to poverty through time spent by women and girls fetching drinkable water from long distances.

### BRIEF SUMMARY OF THE INVENTION

The national level monitoring investigation carried out by Pakistan Council of Research in Water Resources (PCRWR) in 24 major districts have revealed that the access to safe drinking water in urban areas is only 15% and in rural areas 18%. These studies have also identified the excessive levels of Bacteriological contamination, Arsenic, Nitrate, Fluoride, Turbidity and Dissolved Salts in drinking water sources of Pakistan.

In the context of water treatment, Turbidity has the potential to block the Ultravoilet-A light needed for disinfection by the sun, harbor adsorbed chemicals and pathogens, cause negative odor and aesthetics, and even negate the effects of chlorination.

Highly turbid water consumed in rural settings may lead to adverse effects on the quality of life due to cholera, diarrhea, typhoid, hepatitis A & E caused by microbiological contaminants hidden in the turbid water. Turbidity has been linked epidemiologically to various health outcomes and is a measure of the relative clarity of water. Turbidity values above 5 NTU become perceptible to the eye, especially in large volumes such as a white sink or bath. This effect might be increased if the water also contains colored materials such as humic acid or inorganic colored products such as iron compounds.

Turbidity in water is caused by suspended and colloidal matter, such as clay, silt, finely divided organic and inorganic matter, plankton and other microscopic organisms. The World Health Organization and other UN agencies advocate for the implementation of low-cost treatment at the household level as a mean of providing water that is free of microbiological organisms associated with waterborne diseases. Turbidity has been revealed as one of the major water quality concerns specifically in rural areas of Southern Punjab and Central Sindh, where the native people and livestock use highly turbid water for drinking purpose and for other domestic consumptions and thus lead to several water borne diseases. Considering the prevailing drinking water problems, the development of a low cost turbidity removal solution is undertaken specifically for the use in areas, where drinking water is turbid and possibly a cause of waterborne infections or epidemics.

### BRIEF DESCRIPTION OF THE DRAWING

FIG. 1 depicts addition of ingredients in highly turbid water.

FIG. 2 depicts stirring to mix the powder ingredients.

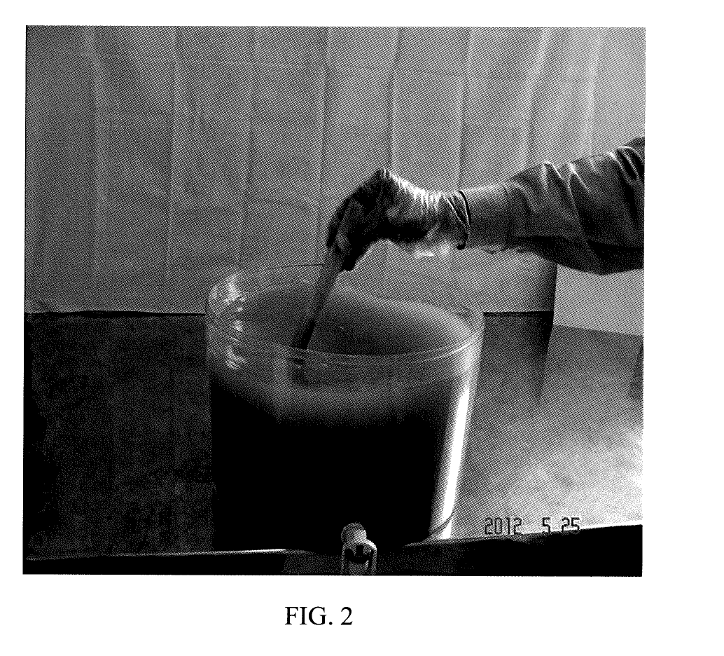

FIG. 3 depicts filtration through 10 layers of Muslin Cloth.

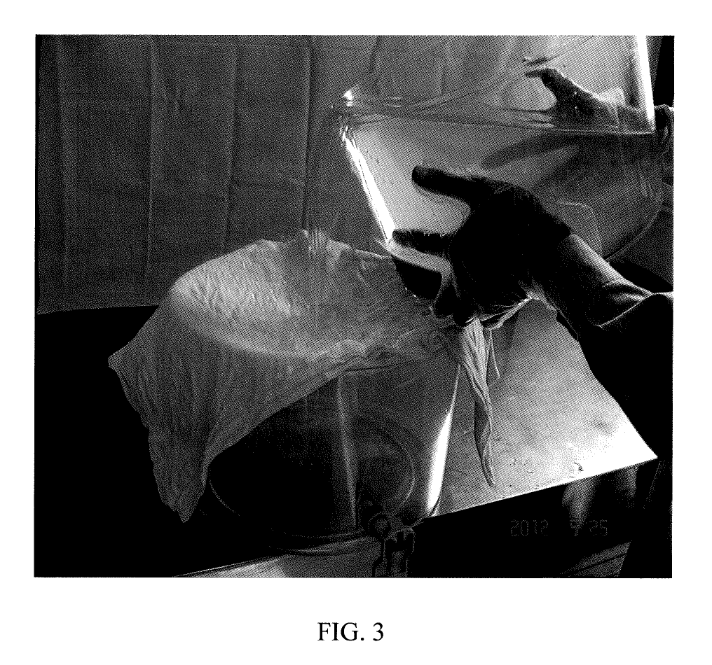

FIG. 4 depicts clear water after flocculation and filtration.

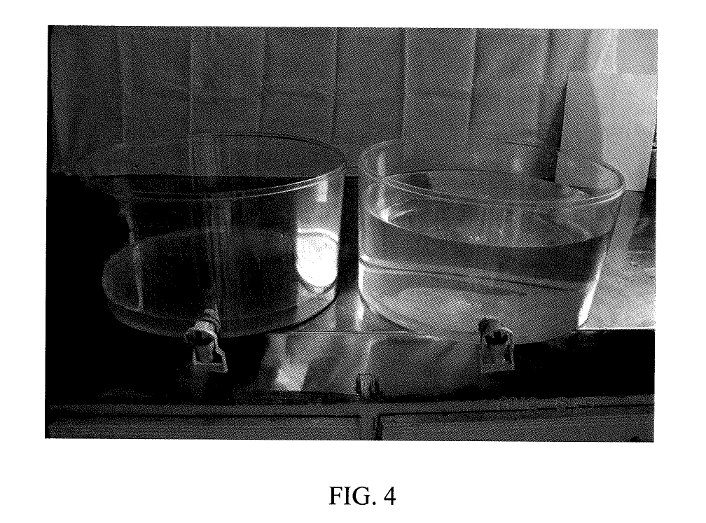

FIG. 5 depicts continuous turbidity evaluation.

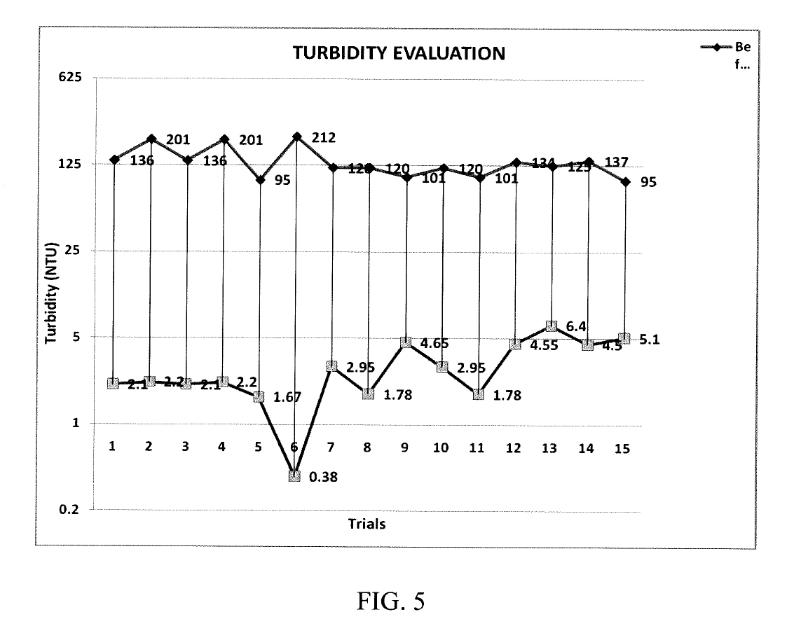

### DETAILED DESCRIPTION OF THE INVENTION

1. The product is effective to remove the turbidity up to above 95%, is effective against microbiological contamination, and the product does not disturb the water quality of treated water above the unsafe levels

The number of compositions using most effective chemicals was formulated to perform experiments with surface water collected from reservoirs, rivers and streams falling in the variable turbidity range of maximum value up to 200 NTU. Intensive experimentation was performed with 25 liters volume of water in order to finalize the most effective composition with high output in terms of turbidity removal efficiency. Thus; the final composition of the “Turbidity Removal Solution” is weighing of powder ingredients, adding the powder ingredients into 25 liters of turbid water in order to optimize the weight Vs volume ratio and, stirring in order to mix the ingredients in water.

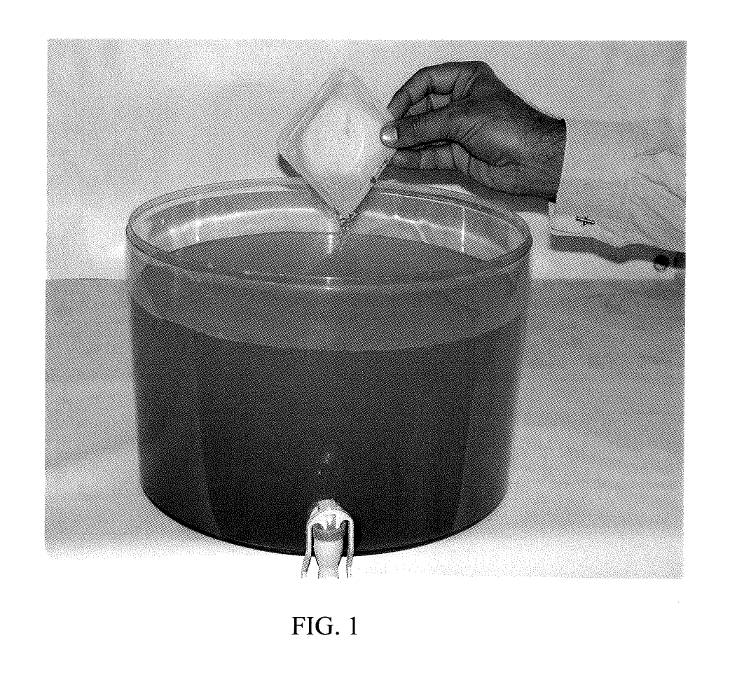

After addition of powder ingredients, stirring for 3 minutes (FIG. 1) and flocculation or settling. After stirring, mixture is left for optimum flocculation/settling in minimum period of time. The number of observations has indicated that a minimum time of 10 minutes will be required for an optimum flocculation and filtration through multiple layers i.e., 10-16 layers of Muslin cloth and storage of treated water. Treated water was stored in a container having a lid to avoid the further contamination with microbial contaminants.

Laboratory testing for microbiological and detailed water quality parameters following the APHA standard methods has revealed that that quality of treated water using the optimized treatment composition and contact time have not caused excess of any parameter than safe water permissible limits of WHO or PSQCA. This has led to the conclusions that the product is effective against turbidity and microbiological contamination; the product is effective to remove the turbidity up to above 97%; the product does not required high-tech filtration solution to bring the contaminated water within safe limits; and, the product does not disturb the water quality of treated water above unsafe levels

What is claimed is:

1. A composition for purifying water comprising essentially 14 g bentonite clay, 8 g sodiu7m carbonate, 2.4 g calcium hypochlorite and 10 g of alum; said composition being in the form of a substantially dry powder when said composition is added to water

2. The composition of claim 1, wherein said composition removes turbidity up to a level of 200 NTU.
